(19) United States
(12) Patent Application Publication
(10) Pub. No.: US 2018/0356663 A1
(43) Pub. Date: Dec. 13, 2018

(54) LIQUID CRYSTAL DISPLAY DEVICE

(71) Applicant: Wuhan China Star Optoelectronics Technology Co., Ltd., Wuhan (CN)

(72) Inventors: Hongsen ZHANG, Wuhan (CN); Yao-li HUANG, Wuhan (CN)

(73) Assignee: Wuhan China Star Optoelectronics Technology Co., Ltd., Wuhan (CN)

(21) Appl. No.: 15/568,907

(22) PCT Filed: May 3, 2017
(86) PCT No.: PCT/CN2017/082818

§ 371 Date: Oct. 24, 2017

(30) Foreign Application Priority Data
Mar. 30, 2017 (CN) 201710203294.1

(51) Int. Cl. G02F 1/1333; G02F 1/1362; G06F 3/041

(52) U.S. Cl. CPC G02F 1/13338; G02F 1/136286; G06F 3/0412; G02B 6/0081; G02F 2001/133331; G02F 2202/28; G02F 2001/133317; G06F 3/0414

(57) ABSTRACT

A liquid crystal display device is disclosed in the present disclosure, which includes a liquid crystal display panel and a backlight module, with a gap disposed between the liquid crystal display panel and the backlight module, wherein the liquid crystal display panel includes an array substrate including a touch force sensing electrode disposed thereupon, the backlight module includes a backlight source and a metal backplane disposed on a bottom of the backlight source, and a touch force sensing capacitor of the liquid crystal display device is composed of the touch force sensing electrode and the metal backplane.

### FIELD OF THE INVENTION

The present disclosure relates to the technical field of liquid crystal display devices, and particularly to a liquid crystal display device with a new embedded force touch technology.

### BACKGROUND OF THE INVENTION

Force touch technology has now begun to gradually apply to consumer products such as mobile phones, tablets, and so on. It has been classified into types of piezo-resistive, piezo-electric, and capacitive based on the operational principle, with the capacitive technology being relatively mature and the most widely used. According to different positions of a touch sensing electrode among the capacitive force touch panels, the capacitive force touch panels can be divided into a conventional force touch technology and a new embedded force touch technology. Whether the technology is the conventional technology or new capacitive force touch technology, both need another sensor electrode (must be connected to GND) in addition to the force touch sensing electrode since the technology is capacitive.

Another sensor electrode used for the conventional force touch technology had been achieved by using a middle frame of a mobile phone, because there is a gap (air gap) between the middle frame of the mobile phone and a backlight module at the bottom of the LCD. The air gap of this mechanism generally is relatively large, but the limit of cumulative tolerances from other mechanisms has a greater impact on the air gap. When a screen of the mobile phone is pressed, the panel will be deformed to change the air gap between the panel and the middle frame, followed by changing the capacitance between the touch sensing electrode and the another sensor electrode (middle frame). The force touch is implemented by detecting the variation of the capacitance of capacitive touch panel.

A higher precision of the air gap is required while the smaller air gap has to be manufactured for new embedded force touch technology. Thus, the limit of cumulative tolerances from other mechanisms have to be reduced, otherwise they will affect the precision of the air gap. Then, it is unable to meet the demand of the air gap for the force touch technology according to the mechanism design of the air gap of the conventional force touch technology, thereby resulting in being unable to realize the force touch function.

As a result, it is necessary to provide a liquid crystal display device capable of realizing an embedded capacitive force touch function to solve a problem existing in the prior art.

### SUMMARY OF THE INVENTION

An object of the present disclosure is to provide a liquid crystal display device which is capable of realizing the embedded capacitive force touch function with high stability.

The present disclosure is based on the conventional touch screen, using the touch sensing electrode as the force sensing electrode by using the backplane of the conventional backlight module as the another sensor electrode, while utilizing a gap (air gap) formed between the backlight module and the liquid crystal display panel when the backlight module and the liquid crystal display panel are assembled. Thus, it is easy to press via a finger or the like to realize the force touch function by detecting a capacitance variation between the force sensing electrode and the another sensor electrode. It should be noted that the touch force sensing electrode in the present disclosure is a combination of the touch sensing electrode and the force sensing electrode.

At the same time, the present disclosure solves a problem that the conventional force touch proposal is difficult to mass produce because the gap between the backplane and the middle frame bottom plate is affected by the cumulative tolerances of other mechanisms.

In the embodiments of the present disclosure, a liquid crystal display device is provided, which includes a liquid crystal display panel, a backlight module, and a gap disposed between the liquid crystal display panel and the backlight module;

wherein the liquid crystal display panel includes a color film substrate, an array substrate and a liquid crystal layer disposed between the color film substrate and the array substrate; the array substrate includes a touch force sensing electrode disposed thereupon;
the backlight module includes a backlight source and a metal backplane disposed at a bottom of the backlight source;
wherein a touch force sensing capacitor of the liquid crystal display device is composed of the touch force sensing electrode and the metal backplane;
the touch force sensing capacitor is provided to sense an outer touch force of the liquid crystal display device by detecting a change of the distance of the gap;
wherein the gap is formed through an adhesive frame deposited between peripheries both of the liquid crystal display panel and the backlight module;
a force detecting sensitivity of the liquid crystal display device is adjusted by adjusting the distance of the gap to adjust the touch force sensing capacitor.

In the liquid crystal display device in the present disclosure, the touch force sensing electrode is used for detecting a touch operation position and a touch operation force.

In the liquid crystal display device in the present disclosure, the metal backplane is a hard metal material with excellent electrical conductivity.

In the liquid crystal display device in the present disclosure, the metal backplane is a stainless steel sheet or an iron sheet.

In the liquid crystal display device in the present disclosure, the metal backplane is grounded.

In the liquid crystal display device in the present disclosure, the height of the gap is 0.1 mm to 0.5 mm.

In the liquid crystal display device in the present disclosure, the liquid crystal display device further includes a protective glass, which is disposed on the liquid crystal display panel via an OCA (Optical Clear Adhesive) optical adhesive.

In the liquid crystal display device in the present disclosure, the liquid crystal display device further includes a middle frame used for enclosing the liquid crystal display panel and the backlight module, the top of the four side walls of the middle frame is provided with a flange protruding outwardly, the flange is formed into a frame-like structure around the four side walls, the flange and the periphery of the protective glass are connected fixedly via an adhesive.

Compared with the prior art, the present disclosure has the following advantages: the liquid crystal display device of the present disclosure is configured such that it disposes the touch force sensing capacitor of the liquid crystal display device composed of the touch force sensing electrode and the metal backplane, to reduce the effect of the accumulated tolerances on the gap between the backlight module and the liquid crystal display panel, and improves the stability of the gap, and thereby embodies the force touch function and mass production easily. Furthermore, the present disclosure is configured such that it uses the touch sensing electrode of the conventional touch screen as the force sensing electrode at the same time by a design of the touch force sensing electrode. It can reduce the cost and realize the integration of the display, touch, and force touch functions of the products to improve the value of the products. Thus, it resolves the technical problem of the liquid crystal display device in the prior art, such as being unable to realize a function of the embedded capacitive force touch, and a poor stability of the conventional touch force sensing capacitance.

In order that the foregoing of the present disclosure will become more apparent, the preferred embodiments are given hereafter and are to be described in detail with reference to the accompanying drawings as below:

### BRIEF DESCRIPTION OF THE DRAWINGS

FIG. 1 is a schematic view of a preferred embodiment of the liquid crystal display device of the present disclosure in a non-pressing state.

FIG. 2 is a schematic view of a preferred embodiment of the liquid crystal display device of the present disclosure in a pressing state.

### DETAILED DESCRIPTION OF THE PREFERRED EMBODIMENTS

Please refer to figures, wherein the same assembly symbol represents the same assembly. The principles of the present disclosure are exemplified by implementation in a suitable computing environment. The following description is based on the specific embodiments of the present disclosure illustrated, and should not be construed as limiting other specific embodiments of the present disclosure which are not detailed herein.

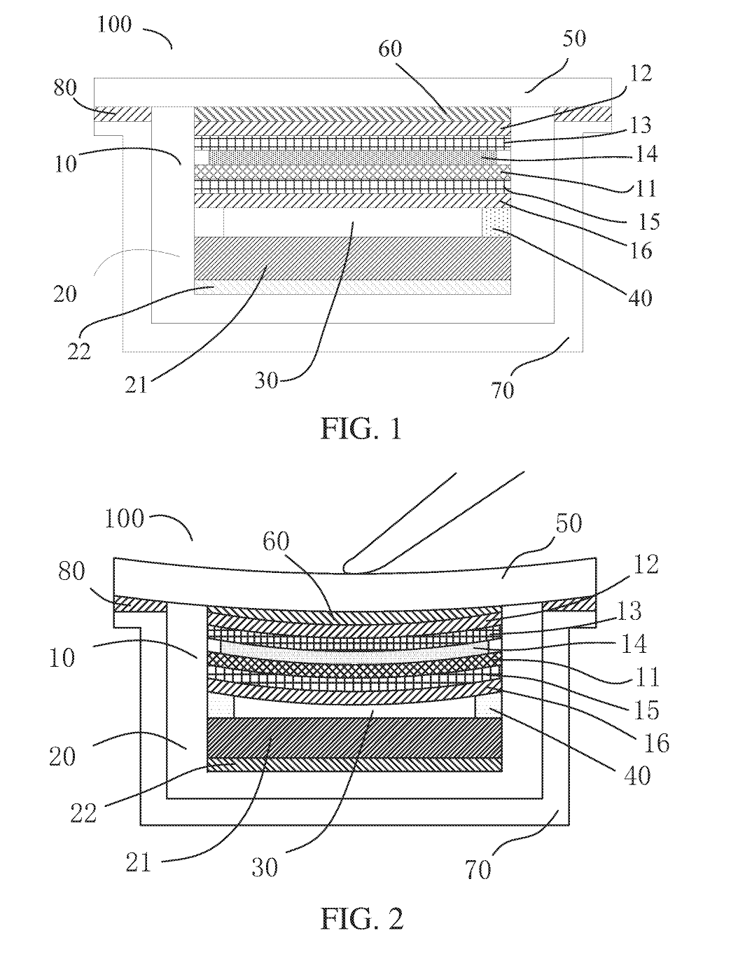

Please refer to FIG. 1 and FIG. 2, wherein FIG. 1 is a schematic view of a preferred embodiment of the liquid crystal display device of the present disclosure in a non-pressing state, and FIG. 2 is a schematic view of a preferred embodiment of the liquid crystal display device of the present disclosure in a pressing state. The liquid crystal display device 100 of the present disclosure includes a liquid crystal display panel 10, a backlight module 20, an adhesive frame 40, a protecting glass 50, an OCA optical adhesive 60, a middle frame 70, and an adhesive 80.

The liquid crystal display panel 10 and the backlight module 20 are disposed on the back surface of the liquid crystal display panel 10, with a gap 30 disposed between the liquid crystal display panel 10 and the backlight module 20; the gap 30 corresponds with a compression of a deforming of the liquid crystal display panel 10.

The liquid crystal display panel 10 includes a color film substrate 13, an array substrate 15, and a liquid crystal layer 14 disposed between the color file substrate 13 and the array substrate 15. The liquid crystal layer 14 includes a touch force sensing electrode 11 disposed thereupon.

The backlight module 20 includes a backlight source 21 and a metal backplane 22 disposed on the bottom of the backlight source 21, wherein a touch force sensing capacitor of the liquid crystal display device 100 is composed of the touch force sensing electrode 11 and the metal backplane 22.

The touch force sensing capacitor reflects an outer touch force of the liquid crystal display device 100 by detecting a distance variation of the gap 30.

It should be noted that the touch force sensing electrode 11 has both a touch sensing function and a force sensing function, that is, using the touch sensing electrode as the force sensing electrode in a conventional liquid crystal display device at the same time, with the metal backplane 22 to be used as another sensor electrode. As a result, the touch force sensing capacitor of the liquid crystal display device 100 is composed of the touching force electrode 11 and the metal backplane 22.

In the touch force sensing capacitor, since an area both of the touch force sensing electrode 11 and the metal backplane 22 is constant, the capacitance of the touch force sensing capacitor depends on a distance between the touch force sensing electrode 11 and the metal backplane 22, but both of the thicknesses of the touch force sensing electrode 11 and the metal backplane 22 are constant, so that the capacitance variation of the touch force sensing capacitor depends on a distance variation of the gap 30.

In other words, when the distance variation of the gap 30 is larger and larger, then the capacitance variation of the touch force sensing capacitor is larger and larger, and the outer touch force is also larger and larger, and vice versa.

In the conventional touch liquid crystal display device, the force sensing electrode is disposed on the backplane of the backlight module as well as the another sensor electrode is a bottom board of the middle frame, such that the liquid crystal display device has to be controlled by an independent control force touch chip which is separated from a display chip and a touch chip resulting in a complex structure. On the other hand, the distance of the gap between the force sensing electrode and the another sensor electrode in the conventional capacitive force touch liquid crystal display device is generally designed to be 1 mm to 5 mm, and the cumulative tolerances affecting the amount of the distance is mainly divided into three parts, that are the cumulative tolerance in assembly of liquid crystal display panel and the backlight module is about 0.15 mm, the cumulative tolerance in gluing of the protective glass and the middle frame is about 0.1 mm, the cumulative tolerance of the middle frame is about 0.3 mm, and the total cumulative tolerance (that is the square root of the sum of the square of each tolerance) is about 0.35 mm, which cumulative tolerance is acceptable on the distance design value of the gap, thereby it is achievable on a practical design proposal. However, since the distance of the gap is greatly affected by a plurality of cumulative tolerances and the stability is poor, it is difficult to realize mass production.

In addition, for a conventional embedded touch liquid crystal display device, based on a proposal of a conventional force touch liquid crystal display device which uses the touch sensing electrode as the force sensing electrode at the same time, but the gap (distance between the backlight module and the liquid crystal display panel) is still designed in accordance with a structure of using middle frame as the another sensor electrode, then the gap may not be too large, because there is a very large distance between the force sensing electrode and the backplane of the backlight module. If the gap of the conventional design is maintained, it may cause the capacitance variation to be unable to detect or the capacitance variation to be detected is too low to detect the capacitance variation. On the other hand, in order to make a certain amount of compression as pressing the gap due to a deformation of the liquid crystal display panel, the gap has to have a certain amount capacity, that is, the gap may not be zero or too small, otherwise the capacitance variation is unable to be detected from the force sensing electrode. The gap may generally be designed between 0.1 mm to 0.5 mm. According to the mechanism design of the conventional middle frame force touch proposal, the total cumulative tolerance of 0.35 mm has exceeded the tolerable range of the gap from 0.1 mm to 0.5 mm resulting in becoming impossible to implement and having no possibility of mass production.

So, in the present disclosure, as the touch force sensing capacitor of the liquid crystal display device 100 is composed from the touch force sensing electrode 11 and the metal backplane 22 as well as the effect of the cumulative tolerances on the gap 30 between the backlight module 20 and the liquid crystal display panel 10 is greatly reduced, then the stability of the gap 30 is improved. In addition, the touch force sensing electrode 11 is used to detect the touch operation position and the touch operation force, that is, the touch force sensing electrode 11 has the touch sensing function and the force sensing function, that is, the touch sensing electrode is used as the force sensing electrode in conventional liquid crystal display device at the same time, such a setting can reduce the cost and achieve the integration of the three functions of display, touch, and force touch to improve the value of the products.

In the preferred embodiment of the present disclosure, the gap 30 is formed by disposing the adhesive frame 40 between both peripheries of the liquid crystal display panel 10 and the backlight module 20. Generating enough compression of the gap 30 while pressing, generates a large capacitance variation, enough to be detected by the touch force sensing electrode 11. Specifically, the thickness of the adhesive frame 40 may be increased appropriately so that the gap 30 is sufficiently large.

Further, the force detection sensitivity of the liquid crystal display device 30 is adjusted by adjusting the distance of the gap 30 to adjust the touch sensing capacitance.

In the sensing distance between the touch force sensing electrode 11 and the metal backplane 22, the thickness both of the liquid crystal display panel 10 and the backlight module 20 are constant. So, if it is desired to adjust the sensitivity of the force touch sensing, then it may only be realized by adjusting the size of the gap 30 such as by adjusting the thickness of the adhesive frame 40. While the gap 30 is satisfied of the pressing deformation of the liquid crystal display device 10, if the sensing distance is smaller and smaller, then the sensitivity of the force touch sensing is higher and higher.

In the preferred embodiment of the present invention, as shown in FIG. 1, when the liquid crystal display panel 10 is in the non-pressing state, the liquid crystal display device 10 does not deform in the direction toward the gap 30, and the capacitance variation between the touch force sensing electrode 11 and the metal backplane 22 is zero, the height of the gap 30 is equal to the thickness of the adhesive frame 40.

As shown in FIG. 2, when the liquid crystal display panel 10 is in the pressing state, the liquid crystal display device 10 deforms in the direction toward the gap 30, and the capacitance variation between the touch force sensing electrode 11 and the metal backplane 22 is not zero, the height of the gap 30 is less than the thickness of the adhesive frame 40.

In the preferred embodiment of the present disclosure, the metal backplane 22 of the backlight module 20 is required to be a hard metal material with excellent electrical conductivity such as a stainless steel sheet or an iron sheet, etc. In the case of using hard materials to mainly satisfy the pressing, if a minor deformation of the metal backplane 22 is also generated, then the metal backplane 22 needs to recover in the shortest possible time to ensure that the force touch performance is normal. In addition, the gap 30 affected by the cumulative tolerances is mainly due to the cumulative tolerance generated by installing the backlight module 20 and the liquid crystal display panel 10, but which is very small and substantially negligible. Therefore, the present disclosure can realize the function of embedded force touch.

In addition, in the preferred embodiment of the present disclosure, the metal backplane 22 is grounded, so that a stable reference potential has to be provided to the another sensor electrode.

In the preferred embodiment of the present disclosure, the height of the gap 30 is optionally selected from 0.1 mm to 0.5 mm. Since the amount of compression of the gap 30 insufficiently reacts the deformation amount of the liquid crystal display panel 10 when the distance of the gap 30 is less than 0.1 mm, so that the touch force sensing electrode 11 may not detect the amount of the variation in the actual touch force sensing capacitance or almost impossible to detect the amount of change in the touch force sensing capacitance, then the force touch function may not be realized. When the height of the gap 30 is larger than 0.5 mm, the distance between the touch force sensing electrode 11 and the metal backplane 22 is too large, such that the thickness of the assembly of the liquid crystal display panel 10 and the backlight module 20 too large, so the thickness of the liquid crystal display device 100 is affected. The thinner the better for the liquid crystal display device 100 as demanded by customers may not be met and the product has no competitiveness.

In the preferred embodiment of the present disclosure, the liquid crystal display panel 10 further includes an upper polarizing plate 12 disposed on the color film substrate 13 and a lower polarizing plate 16 disposed on a surface of the array substrate 15, the surface is opposite the liquid crystal layer 14. The backlight source 21 of the backlight module 20 further includes a reflective film, a light guiding plate, a lower diffusion sheet, a prism sheet, and an upper diffusion sheet disposed on the metal backplane 22 in order as well as a light source strip disposed at a side of the light guiding plate. The purpose of backlight module 20 is served in providing a light source to the liquid crystal display panel 10.

According to the above-described structure, the liquid crystal display device 100 further includes a protective glass 50 provided on the liquid crystal display panel 10 via the OCA optical adhesive 60.

In the preferred embodiment of the present disclosure, the liquid crystal display device 100 further includes the middle frame 70 for enclosing the liquid crystal display panel 10 and the backlight module 20, the top of the four side walls of the middle frame 70 is provided with a flange protruding outwardly which is formed into a frame-like structure around the four side walls, the flange and the periphery of the protective glass 60 are connected fixedly via the adhesive 80. The bonding area of the protective glass 60 and the middle frame 70 is increased through the provision of the flange, so as to improve the stability between them.

The force sensing induction process of the preferred embodiment of the present disclosure is as follows:

First, the liquid crystal display panel 10 covered with the protective glass 50 is pressed by the external force, and then the liquid crystal display panel 10 having the upper polarizing plate 12, the color film substrate 13, the liquid crystal layer 14, the touch force sensing electrode 11, the array substrate 15, and the lower polarizing plate 16 is deformed in the direction toward the gap 30.

At the same time, the gap 30 is compressed correspondingly, and the backlight module 20 provided with the backlight 21 and the metal back plate 22 is almost deformed, the distance between the touch force sensing electrode 11 and the metal back plate 22 is changed, thereby the capacitance of the force sensing capacitor is changed.

Finally, determining the force value of the external force by detecting the amount of capacitance variation in the touch force sensing capacitor.

So, it completes the process of force touch induction.

Compared with the prior art, the liquid crystal display device 100 of the present disclosure has the advantages, that the liquid crystal display device 100 of the present invention constitutes the touch force sensing capacitor of the liquid crystal display device 100 by using the touch force sensing electrode 11 and the metal backplane 22, the effect of the accumulated tolerances to the gap 30 between the backlight module 20 and the liquid crystal display panel 10 is reduced, thereby improving the stability of the gap 30, realizing the force touch function and making it easier to mass produce. In addition, the present disclosure realizes to use the touch sensing electrode of the traditional touch screen as the force sensing electrode at the same time by a design of the touch force sensing electrode 11. Thus, the cost is saved and the integration of the product display, touch, and force touch is realized to improve the value of the product.

While the present disclosure has been shown and described with respect to one or more embodiments, a person having ordinary skill in the art will contemplate equivalent variations and modifications based on the reading and understanding of the specification and drawings of the present disclosure. The present disclosure includes all such modifications and variations, and is limited only by the scope of the appended claims. In addition, although only certain features of the present disclosure have been disclosed with respect to only one of several implementations, such features may be associated with one or more other implementations that may be desirable and advantageous for a given or specific application other combinations of features. Also, such terms are intended to be included in a proposal similar to the term “comprising”, the term “comprising”, “having”, “containing” or its modification is used in the specific embodiments or claims.

In view of the above, although the present disclosure has been disclosed in the embodiments as described above, the sequence numbers before the embodiments, such as “first”, “second”, and the like, are used only for convenience of description, and the order of the embodiments of the present disclosure is not limited. Moreover, the above-described embodiments are not intended to limit the present invention, and a person having ordinary skill in the art will be able to make various modifications without departing from the spirit and scope of the present disclosure, and thus the scope of the present disclosure is defined by the scope of the claims.

What is claimed is:

1. A liquid crystal display device, comprising:
a liquid crystal display panel, a backlight module, and a gap disposed between the liquid crystal display panel and the backlight module;
the liquid crystal display panel including a color film substrate, an array substrate, and a liquid crystal layer disposed between the color film substrate and the array substrate;
the array substrate including a touch force sensing electrode disposed thereupon;
the backlight module including a backlight source and a metal backplane disposed at a bottom of the backlight source;
wherein a touch force sensing capacitor of the liquid crystal display device is composed of the touch force sensing electrode and the metal backplane, and the touch force sensing capacitor is provided to sense an outer touch force of the liquid crystal display device by detecting a change of a distance of the gap; and
wherein an adhesive frame is deposited between peripheries of both of the liquid crystal display panel and the backlight module to form the gap, and a force detecting sensitivity of the liquid crystal display device is adjusted by adjusting the distance of the gap to adjust the touch force sensing capacitor.

2. The liquid crystal display device as claimed in claim 1, wherein the touch force sensing electrode is used for detecting a touch operation position and a touch operation force.

3. The liquid crystal display device as claimed in claim 1, wherein the metal backplane is a hard metal material with excellent electrical conductivity.

4. The liquid crystal display device as claimed in claim 3, wherein the metal backplane is a stainless steel sheet or an iron sheet.

5. The liquid crystal display device as claimed in claim 3, wherein the metal backplane is grounded.

6. The liquid crystal display device as claimed in claim 1, wherein a height of the gap is 0.1 mm to 0.5 mm.

7. The liquid crystal display device as claimed in claim 1, wherein the liquid crystal display device further includes a protective glass, which is disposed on the liquid crystal display panel via an OCA (Optical Clear Adhesive) optical adhesive.

8. The liquid crystal display device according to claim 7, wherein the liquid crystal display device further includes a middle frame used for enclosing the liquid crystal display panel and the backlight module, a top of four side walls of the middle frame is provided with a flange protruding outwardly, the flange is formed into a frame-like structure around the four side walls, and the flange and the periphery of the protective glass are connected fixedly via an adhesive.

9. A liquid crystal display device comprising:
a liquid crystal display panel, a backlight module and a gap disposed between the liquid crystal display panel and the backlight module;
the liquid crystal display panel including a color film substrate, an array substrate and a liquid crystal layer disposed between the color film substrate and the array substrate;
the array substrate including a touch force sensing electrode disposed thereupon;
the backlight module including a backlight source and a metal backplane disposed at a bottom of the backlight source;
wherein a touch force sensing capacitor of the liquid crystal display device is composed of the touch force sensing electrode and the metal backplane, and the touch force sensing capacitor is provided to sense an outer touch force of the liquid crystal display device by detecting a change of a distance of the gap; and
wherein the gap is formed through an adhesive frame deposited between peripheries both of the liquid crystal display panel and the backlight module, and a force detecting sensitivity of the liquid crystal display device is adjusted by adjusting the distance of the gap to adjust the touch force sensing capacitor.

10. The liquid crystal display device as claimed in claim 9, wherein an adhesive frame is deposited between peripheries of both of the liquid crystal display panel and the backlight module to form the gap.

11. The liquid crystal display device as claimed in claim 9, wherein a force detecting sensitivity of the liquid crystal display device is adjusted by adjusting the distance of the gap to adjust the touch force sensing capacitor.

12. The liquid crystal display device as claimed in claim 9, wherein the touch force sensing electrode is used for detecting a touch operation position and a touch operation force.

13. The liquid crystal display device as claimed in claim 9, wherein the metal backplane is a hard metal material with excellent electrical conductivity.

14. The liquid crystal display device as claimed in claim 13, wherein the metal backplane is a stainless steel sheet or an iron sheet.

15. The liquid crystal display device as claimed in claim 13, wherein the metal backplane is grounded.

16. The liquid crystal display device as claimed in claim 9, wherein a height of the gap is 0.1 mm to 0.5 mm.

17. The liquid crystal display device as claimed in claim 9, wherein the liquid crystal display device further includes a protective glass, which is disposed on the liquid crystal display panel via an OCA optical adhesive.

18. The liquid crystal display device according to claim 17, wherein the liquid crystal display device further includes a middle frame used for enclosing the liquid crystal display panel and the backlight module, the top of the four side walls of the middle frame is provided with a flange protruding outwardly, the flange is formed into a frame-like structure around the four side walls, and the flange and the periphery of the protective glass are connected fixedly via an adhesive.
